(19) United States
(12) Patent Application Publication
(10) Pub. No.: US 2011/0187084 A1
(43) Pub. Date: Aug. 4, 2011

(54) EXTENDABLE TRAILER WITH NON-BOX BEAM

(76) Inventor: Jeffrey A. Walters, JR., Bradenton, FL (US)

(21) Appl. No.: 12/697,448

(22) Filed: Feb. 1, 2010

(51) Int. Cl. B62D 61/00

(52) U.S. Cl. 280/656

(57) ABSTRACT

An extendable trailer frame including at least one ground engaging wheel for supporting the extendable trailer frame, a connection device for operatively connecting the extendable trailer frame to an associated tractor, a first support assembly, a second support assembly, and a tubular beam assembly operatively connecting the first and second support assemblies, the tubular beam assembly having first and second telescopically joined members, wherein the length of the tubular beam assembly changes as the first and second telescopically joined members move in relation to each other, and wherein one of the first and second telescopically joined members have a cross-section comprising a plurality of curvilinear portions.

### I. BACKGROUND OF THE INVENTION

A. Field of Invention

This invention pertains generally to trailers and more specifically to extendable trailers.

B. Description of the Related Art

It is well known to use semi-tractor and trailers to haul a variety of different loads.

It is also known to have extendable trailers, which can be lengthened or shortened depending upon the size of the load. The extendable trailers have a telescoping beam, which allows the trailer to change length. The cross-section of known telescoping beams is typically rectangular or circular. While known beams work well for their intended use, each shape has its own strengths and weakness depending upon how the beam is loaded.

Therefore, what is needed is an extendable trailer with a telescoping beam having an optimized shaped cross-section for handling forces from many different directions.

### II. SUMMARY

According to one embodiment of this invention, an extendable trailer frame includes at least one ground engaging wheel for supporting the extendable trailer frame; a connection device for operatively connecting the extendable trailer frame to an associated tractor; a first support assembly; a second support assembly; and a tubular beam assembly operatively connecting the first and second support assemblies, the tubular beam assembly having first and second telescopically joined members, wherein the length of the tubular beam assembly changes as the first and second telescopically joined members move in relation to each other, and wherein one of the first and second telescopically joined members have a cross-section comprising a plurality of curvilinear portions. The plurality of curvilinear portions may join together at any angle. In one embodiment, the plurality of curvilinear portions are joined together at obtuse angles. The extendable trailer frame may include a locking mechanism having a locked condition and an unlocked condition, wherein the locked condition maintains the length of the tubular beam assembly, and wherein the unlocked condition allows the length of the tubular beam assembly to adjust. The extendable trailer frame may include one or more adjustment mechanisms for changing the length of the tubular beam assembly. In one embodiment, the adjustment mechanism is a hydraulic cylinder. The extendable trailer frame may include a second tubular beam assembly operatively connecting the first and second support assemblies, the second tubular beam assembly having first and second telescopically joined members, wherein the length of the tubular beam assembly changes as the first and second telescopically joined members move in relation to each other, and wherein a cross-section of the telescopically joined members has a plurality of curvilinear portions joined together at obtuse angles. In one embodiment, the cross-section of the telescopically joined members includes a substantially linear portion positioned between two curvilinear portions, wherein the substantially linear portion and the two curvilinear portions are joined together at obtuse angles. The tubular beam assembly may be positioned in a variety of ways. Changing the length of the tubular beam assembly may change the length or the width of the extendable trailer frame. in one embodiment, both the first and second telescopically joined members have cross-sections comprising a plurality of curvilinear portions joined together at obtuse angles.

According to another embodiment of this invention, an extendable trailer includes at least one ground engaging wheel operatively connected to the extendable trailer for supporting the extendable trailer; a connection device operatively connected to the extendable trailer for connecting the extendable trailer to an associated tractor; a load receiving surface; and an extendable trailer frame. The extendable trailer frame may include a front support assembly; a rear support assembly; and a tubular beam assembly operatively connecting the front and rear support assemblies, the tubular beam assembly having first and second telescopically joined members, wherein the length of the extendable trailer frame changes as the first and second telescopically joined members move in relation to each other, and wherein a cross-section of the telescoping joined members includes a plurality of outwardly curved portions. The outwardly curved portion may join together at any angle. In one embodiment, the outwardly curved portions joined together at obtuse angles. The cross-section of the telescopically joined members may include three outwardly curved portions joined together at obtuse angles. The cross-section of the telescopically joined members may include a substantially linear portion positioned between two outwardly curved portions, wherein the substantially linear portion and the two outwardly curved portions are joined together at obtuse angles.

One advantage of this invention is the enhanced strength and rigidity of the telescoping beam.

Another advantage of this invention is the increase in load bearing without the increase in the amount, thickness, or weight of material used for the telescoping beam.

Still other benefits and advantages of the invention will become apparent to those skilled in the art to which it pertains upon a reading and understanding of the following detailed specification.

### III. BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 is a perspective view of a semi-tractor and an extendable trailer, according to one embodiment;

FIG. 2 is a perspective view of a semi-tractor and an extendable trailer, according to another embodiment;

FIG. 3 is a partial side view of the extendable trailer frame shown in FIG. 2;

FIG. 4 is a perspective view of an extendable trailer frame, according to one embodiment;

FIG. 5 is a top view of the extendable trailer frame shown in FIG. 4;

FIG. 6 is a side view of the extendable trailer frame shown in FIG. 4;

FIG. 7 is a top view of an extendable trailer frame, according to another embodiment;

FIG. 8 is cross-sectional view of the extendable trailer frame shown in FIG. 7;

FIG. 9 is perspective view of an extension device, according to one embodiment;

FIG. 10 is cross-sectional view of a tubular beam assembly, according to one embodiment;

FIG. 11 is cross-sectional view of a tubular beam assembly, according to another embodiment;

FIG. 12 is cross-sectional view of a tubular beam assembly, according to another embodiment;

FIG. 13 is cross-sectional view of a tubular beam assembly, according to another embodiment;

FIG. 14 is cross-sectional view of a tubular beam assembly, according to another embodiment;

FIG. 15 is cross-sectional view of a tubular beam assembly, according to another embodiment.

### IV. DETAILED DESCRIPTION

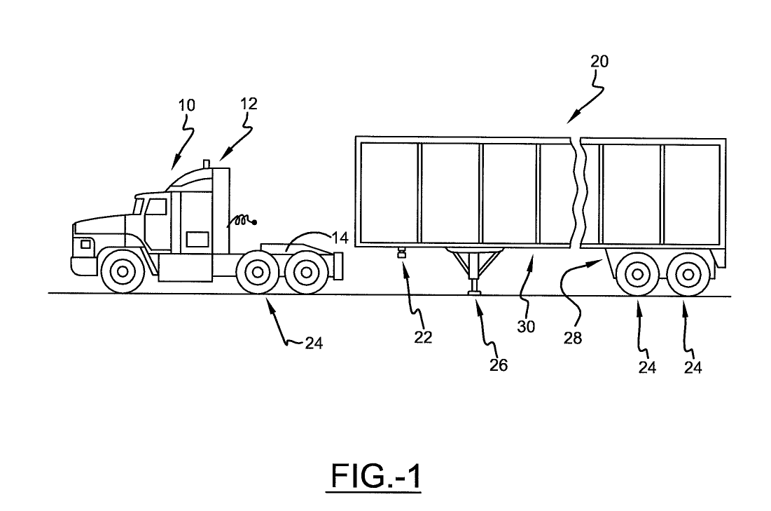

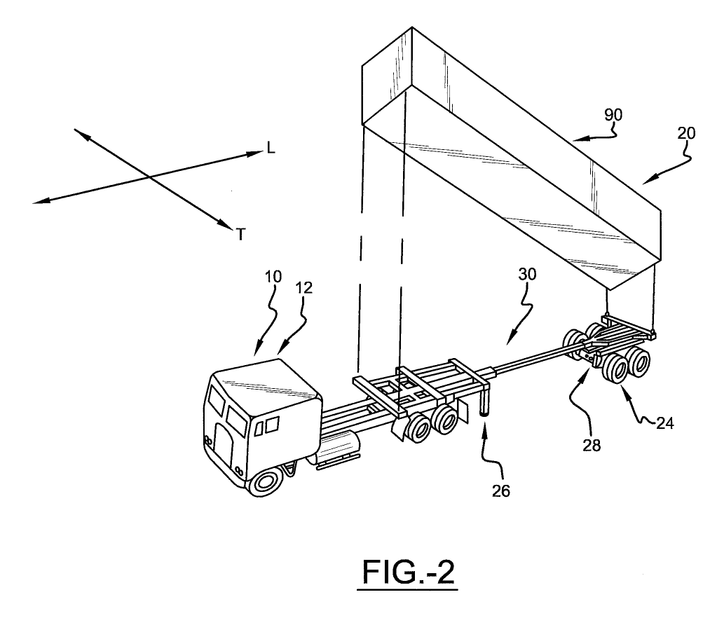

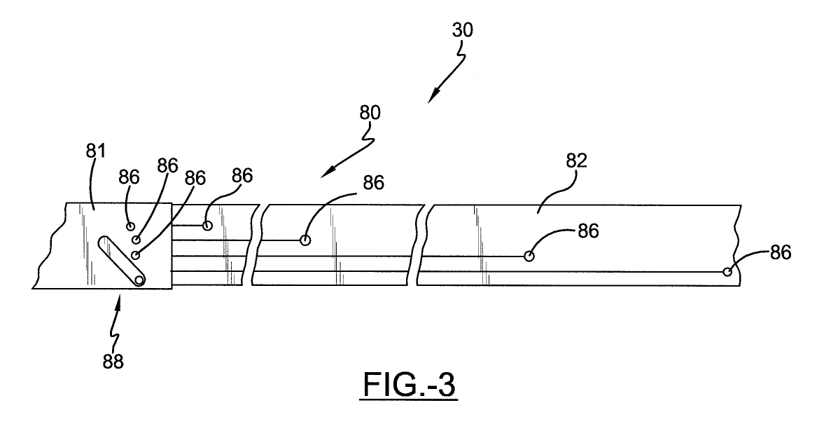

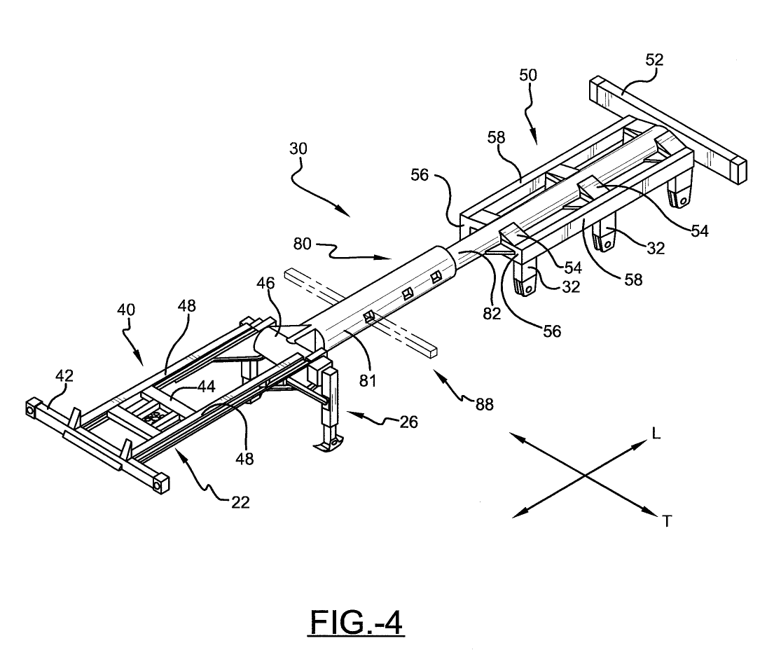

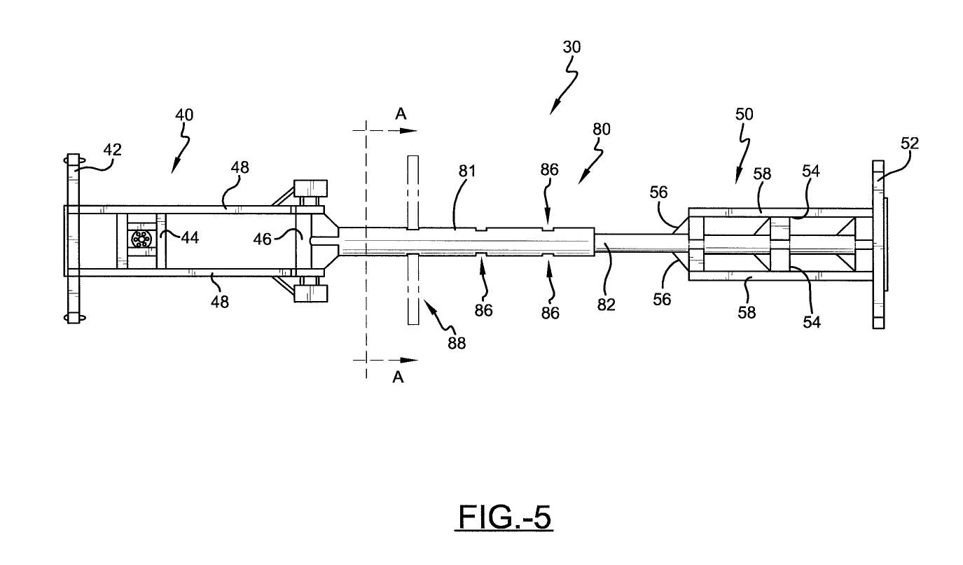

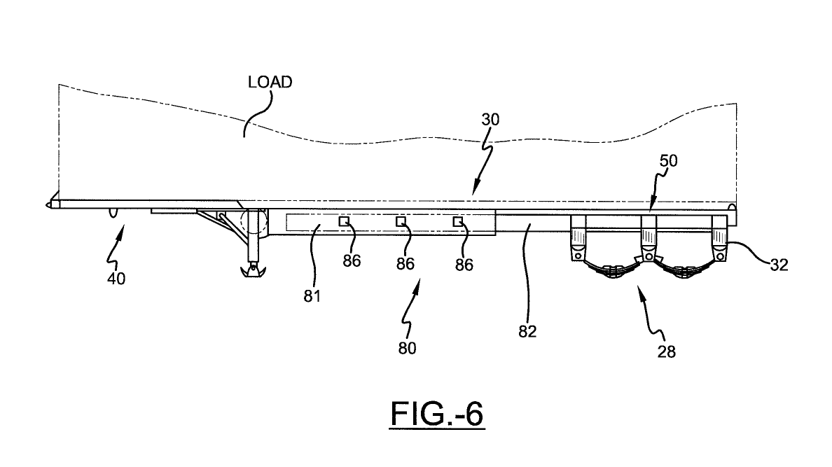

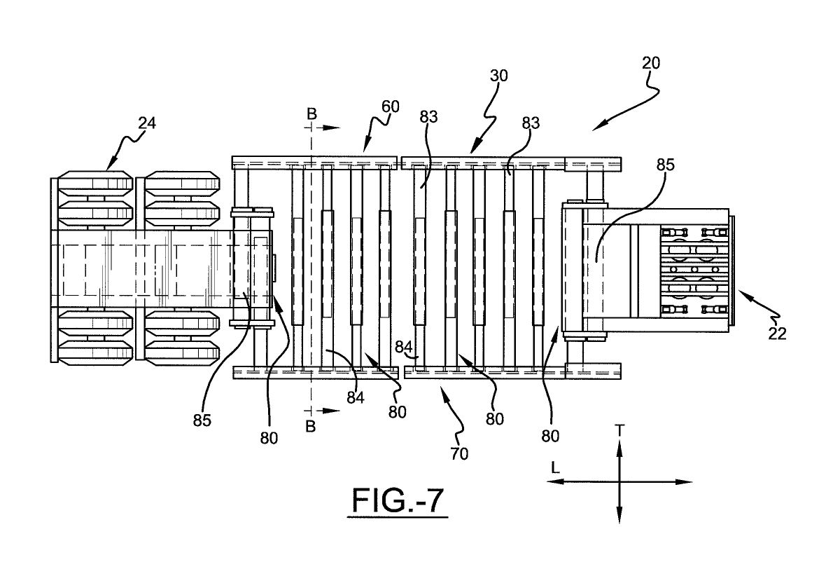

Referring to the drawings wherein the showings are for purposes of illustrating embodiments of the invention only and not for purposes of limiting the same, and wherein like reference numerals are understood to refer to like components, FIGS. 1 and 2 show a tractor 10 and an extendable trailer 20 for transporting various goods, according to an embodiment of this invention. The tractor 10 may be any type of semi-tractor, semi-truck, semi-trailer truck, or tractor-trailer. The tractor 10 may include a cab 12 and fifth wheel 14, as is well known in the art. The extendable trailer 20 may be any type of trailer including, but not limited to, a flatbed trailer, a lowboy trailer, a dump trailer, a tagalong trailer, a box or van trailer, a curtain slider trailer, a drop-deck trailer, a gooseneck trailer, and a double-decker trailer. The trailer 20 may include a connection device 22 for connecting to the fifth wheel 14 of the tractor 10. In one embodiment, the connection device 22 is a kingpin, as is well known in the art. The trailer 20 may include a wheel or undercarriage assembly 28. The trailer 20 may include one or more ground-engaging wheels 24 for supporting the rear of the trailer 20. The trailer 20 may include a retractable landing gear assembly 26 for supporting the front of the trailer 20, when the trailer 20 is not connected to the tractor 10. The trailer 20 may include an extendable frame 30, which may extend and retract to change a dimension of the trailer 20. In one embodiment, the frame 30 extends and retracts the trailer 20 along the length or longitudinal axis L of the trailer 20, shown in FIGS. 2-6. In another embodiment, the frame 30 extends and retracts the trailer 20 along the width or transverse axis T of the trailer, shown in FIG. 7. The extendable frame 30 may receive and support different sized shipping containers 40, including, but not limited to, standard sized shipping containers. The extendable frame 30 may be formed of metal.

With reference now to FIGS. 2-6, the trailer frame 30 may include a front support assembly 40, a rear support assembly 50, and a tubular beam assembly 80. The front support assembly 40 may include a connection device 22, a front cross member 42, one or more intermediate cross members 44, a rear cross member 46, and side rails 48. The rear support assembly 50 may include one or more undercarriage support members 32, a rear cross member 52, one or more intermediate cross members 54, a front cross member 56, and side rails 58. The cross members may maintain the position and orientation of the side rails. The cross members may extend between the side rails or across the top or bottom of the side rails or across the ends of the side rails. The cross members may extend between one or both of the side rails and the tubular beam assembly 80. The cross member may extend at least partially inside a portion of the tubular beam assembly 80. The cross members may maintain the position and orientation of the tubular beam assembly 80 in relation to the side rails. The tubular beam assembly 80 may extend from the front cross member 42 of the front support assembly 40 to the rear cross member 52 of the rear support assembly 50. Alternatively, the tubular beam assembly 80 may extend from any portion of the front support assembly 40 to any portion of the rear support assembly 50. In one embodiment, the tubular beam assembly 80 extends from the rear cross member 46 of the front support assembly 40 to the rear cross member 52 of the rear support assembly 50. In another embodiment, the tubular beam assembly 80 extends from the rear cross member 46 of the front support assembly 40 to the front cross member 56 of the rear support assembly 50.

With continuing reference to FIGS. 2-6, the tubular beam assembly 80 may include a front section 81 and a rear section 82, which are sized to fit together telescopically. In one embodiment, the front section 81 may telescopically receive the rear section 82. In another embodiment, the rear section 82 may telescopically receive the front section 81. The front section 81 may include one or apertures 86 at predetermined distances along the tubular beam assembly 80. The rear section 82 may include one or apertures 86 at predetermined distances along the tubular beam assembly 80. The length of the tubular beam assembly 80 can be adjusted by the relative movement between the front section 81 and the rear section 82. Either section 81, 82 could be fixed in relation to the other section or both section 81, 82 could be movable. The length of the tubular beam assembly 80 can be set at a specific length when the apertures 86 on the front section 81 and rear section 82 are aligned and then a locking mechanism 88 is inserted into the aligned apertures 86. The locking mechanism 88 may be a bar or pin inserted into the apertures 86. In one embodiment, changing the length of the tubular beam assembly 80 changes the length of the trailer 20 along the longitudinal axis L of the trailer 20. In another embodiment, changing the length of the tubular beam assembly 80 changes the width of the trailer 20 along the transverse axis T of the trailer 20. The tubular beam assembly 80 may provide a conduit for electrical cables and hydraulic conduits to pass through. Any of the frame members, rails, or assemblies may have any shape chosen with ordinary skill in the art including, but not limited to, a rectangular bar or tube, an elliptical bar or tube, a circular bar or tube, an I-beam, an H-beam, an L-beam, an angle iron, and a flat metal plate. Any of the frame members, rails, or assemblies may be attached by any means chosen with ordinary skill in the art including, but not limited to, welding and fasteners.

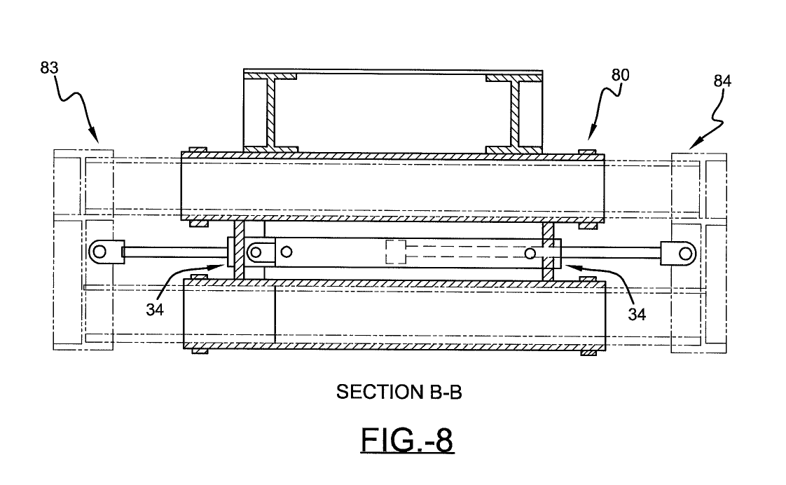

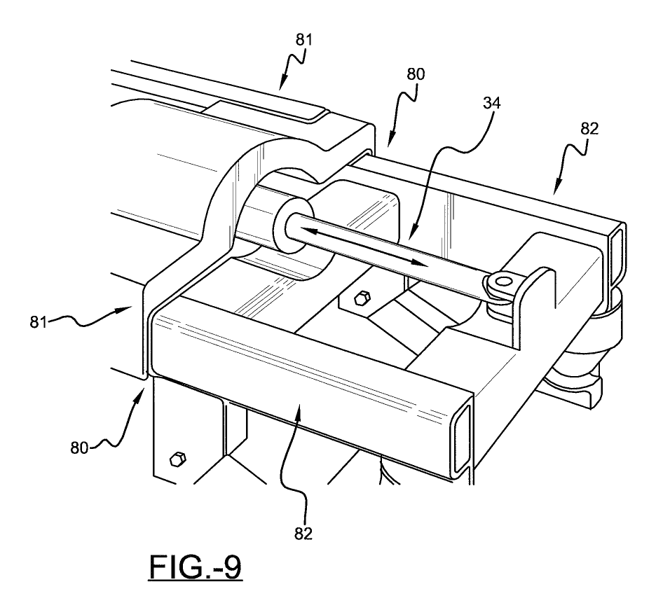

With reference now to FIGS. 7 and 8, the tubular assembly 80 may include a left section 83 and a right section 84. The left and rights section 83, 84 may telescopically interconnect, where the left section 83 may telescopically receive the right section 84 or the right section 84 may telescopically receive the left section. The length of the tubular beam assembly 80 can be adjusted by the relative movement between the left section 83 and the right section 84. The tubular assembly 80 may also include a center section 85. The center section 85 may telescopically receive the left section 83 and/or the right section 84. The length of the tubular beam assembly 80 can be adjusted by the relative movement between the left section 83 and the center section 85, and/or between the right section 84 and the center section 85. In one embodiment, an adjustment mechanism 34 may extend and retract the left and right sections 83, 84, shown in FIG. 8. In another embodiment, the adjustment mechanism 34 may extend and retract the front and rear sections 81, 82, shown in FIG. 9. In one embodiment, the adjustment mechanism 34 is a hydraulic cylinder. In another embodiment, the adjustment mechanism 34 is a pneumatic cylinder.

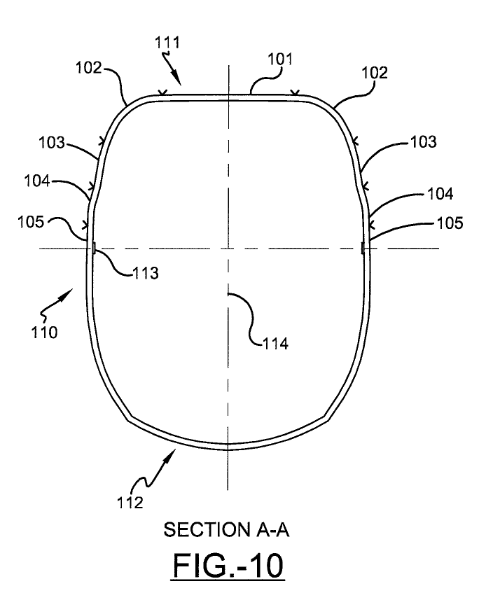

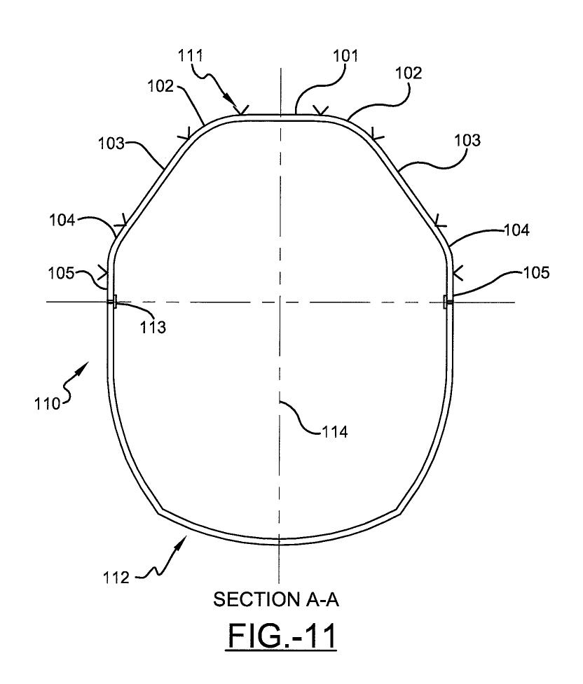

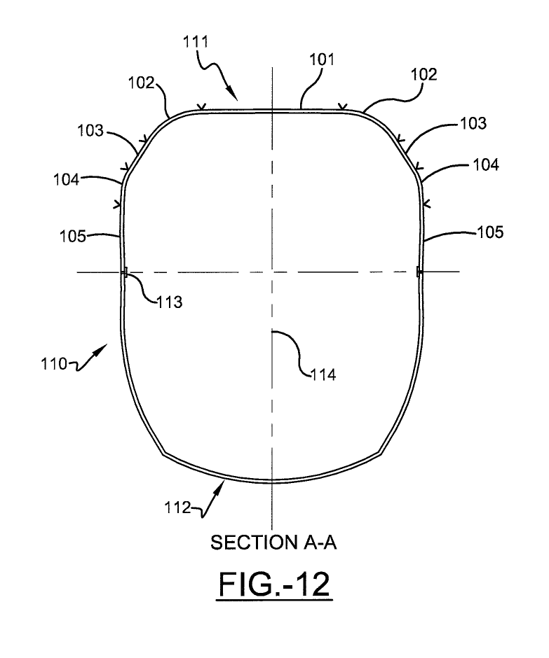

With reference now to FIGS. 10-15, the cross section 110 of the tubular beam assembly 80 (including the telescoping front and rear sections 81, 82; the left and right sections 83, 84; and the center section 85) may include a plurality of curvilinear portions or segments, which join together at obtuse angles. In one embodiment, the curvilinear portions or segments have a substantially outwardly curved shape. In another embodiment, the curvilinear portions or segments have a substantially arc shape including, but not limited to, a circular arc, an elliptical arc, and a hyperbolic arc. The cross section 110 of the tubular beam assembly 80 may include substantially straight or linear portions or segments. The curvilinear segments may join together at any angle including, but not limited to a reflex angle, a straight angle, an obtuse angle, a right angle, or an acute angle. The curvilinear and substantially linear segments may join together at any angle including, but not limited to a reflex angle, a straight angle, an obtuse angle, a right angle, or an acute angle. The substantially linear segments may join together at any angle including, but not limited to a reflex angle, a straight angle, an obtuse angle, a right angle, or an acute angle. The cross section 110 of the tubular beam assembly 80 may include an upper profile 111 and a lower profile 112 which are connected to each other, such as by welding, at weld 113. The upper profile 111 and the lower profile 112 may join together at any angle including, but not limited to a reflex angle, a straight angle, an obtuse angle, a right angle, or an acute angle. In one embodiment, the upper profile 111 and the lower profile 112 have approximately the same vertical height.

With reference now to FIGS. 10-12, the upper profile 111 may include a substantially linear central segment 101, which extends symmetrically to both sides of the vertical longitudinal plane 114 of the section. In one embodiment, this central portion 101 forms the longest substantially linear cross-sectional segment of the upper profile 111. In another embodiment, the length of the central substantially linear portion 101 is equal to or shorter than the length of substantially linear cross-sectional portion 103. In another embodiment, the lengths of the substantially linear cross-sectional portions 103 are equal to or shorter than the lengths of the third substantially linear portions 105. The upper profile 111 may include outwardly curved cross-sectional segments 102 connected to each side of the cross-sectional segment 101. The upper profile 111 may include substantially linear cross-sectional segments 103 connected to the outwardly curved cross-sectional segments 102. The upper profile 111 may include outwardly curved cross-sectional segments 104 connected to the substantially linear cross-sectional segments 103. The upper profile 111 may include substantially linear cross-sectional segments 105 connected to the curved cross-sectional segments 104. In one embodiment, the outwardly curved cross-sectional segments 102 have a smaller radius of curvature than the outwardly curved cross-sectional segments 104.

With continuing reference to FIGS. 10-12, The substantially linear cross-sectional segments 105 may form the lowermost or termination points of the upper cross sectional section 111. At the lower edge of the substantially linear cross-sectional segments 105, the upper profile 111 may be connected to the lower profile 112 at location 113. In one embodiment, the upper profile 111 includes five substantially linear cross-sectional segments 101, 103, 103, 105, 105 and four outwardly curved cross-sectional segments 102, 102, 104, 104. In a more specific embodiment, the substantially linear segments alternate with the outwardly curved segments. In one embodiment, the transitions between the substantially linear segments and the outwardly curved segments are tangential. In another embodiment, the transitions between the substantially linear segments and the outwardly curved segments are at obtuse angles. The curved cross-sectional segments may act as stiffeners to counteract buckling. The substantially linear cross-sectional segments may facilitate manufacturing the tubular beam assembly 80.

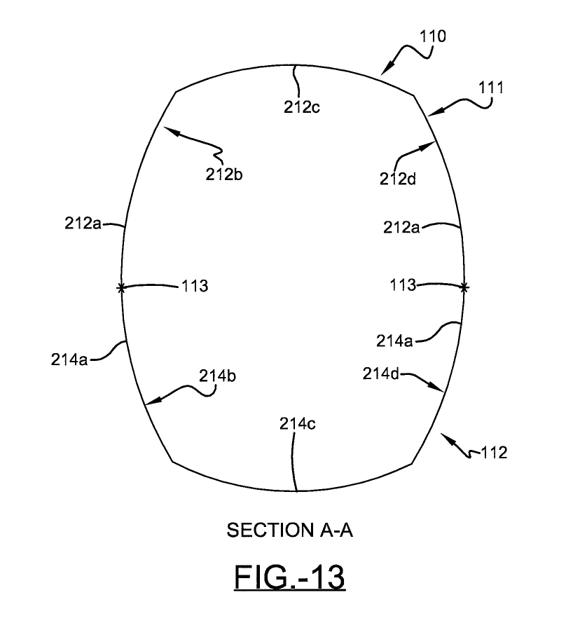

With reference to FIGS. 13-15, the cross section 110 of the tubular beam assembly 80 may include free leg ends or segments 212a and 214a of the two profile sections 111, 112. The segments 212a and 214a may be substantially straight or linear. The lower profile 112 may be formed by three outwardly curved shell segments 214b, 214c and 214d, as shown in FIG. 13. Segments 214b and 214d may each include one of the straight leg portions 214a, which are welded to the upper profile 111. The upper profile 111 may include three outwardly curved shell segments 212b, 212c and 212d. Each segment 212b, 212c, 212d, 214b, 214c, and 214d may have the shape of a circular arc, with the same or different radii of curvature. The two shell segments 212b and 212d may include the substantially straight or linear segments 212a, which are welded to the straight segments 214a of the lower profile 112. The shell segments 212b, 212c, and 212d may form obtuse angles with each other at their respective meeting or connecting points and at the points where the shell segments 212b, 212d meet with the respective connecting straight segments 212a. The lower profile segments 214a, 214b, 214c and 214d may form obtuse angles with each other at their respective meeting or connecting points and at the points where the shell segments 214b, 214d meet with the respective connecting straight segments 214a.

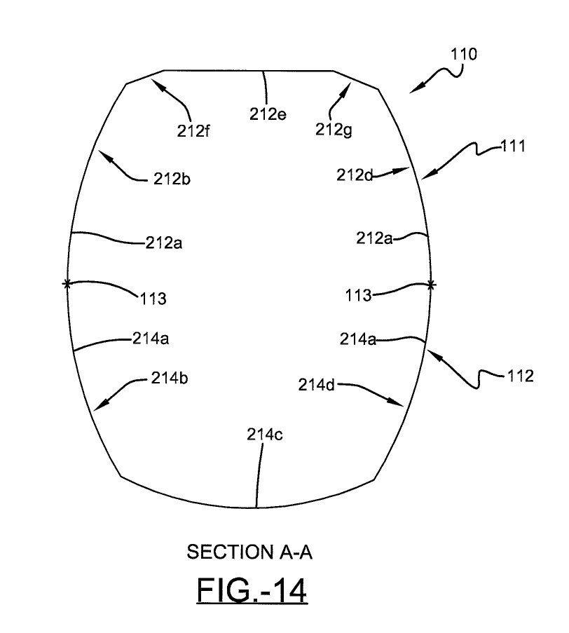

With continuing reference to FIGS. 13-15, the upper profile 111 may include a substantially straight or linear shell segment 212e and a pair of short outwardly curved segments 212f and 212g, which are connected to the straight segment 212e, as shown in FIG. 14. The curved segments 212f and 212g are also connected to curved segments 212b, 212d, respectively. Each of these segments may meet at obtuse angles as discussed above. The upper and lower profiles may include other substantially straight or linear segments or additional substantially straight or linear segments between the outwardly curved shell segments 212b and 212f and between the outwardly curved shell segments 212g and 212d. The upper and lower profiles 111, 112 may include at least two curved shell segments and may include any even or odd number of curved shell segments.

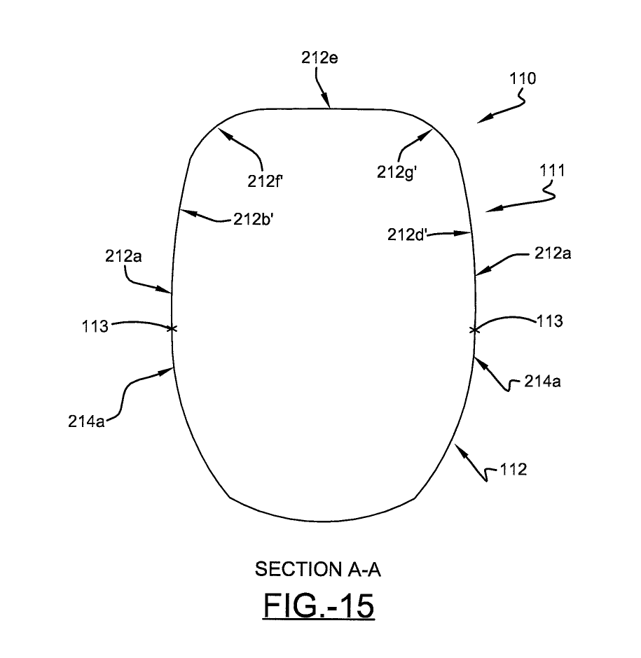

With continuing reference to FIGS. 13-15, the upper profile 111 may includes a substantially linear or straight segment 212e, as shown in FIG. 15. Segment 12e may be joined at its ends to outwardly curved shell segments 212g′ and 212f′ at the right and left upper corners of the upper profile 111. Curved segments 212g′ and 212f′ may have a relatively small radius of curvature. Segments 212g′ and 12f′ may merge tangentially into the central straight shell segment 212e on one side and into the outwardly curved shell segments 212b′ and 212d′, respectively, on their other sides. The outwardly curved segments of the tubular beam assembly 80 provide excellent resistance to compressive forces. The relatively sharp “creases” formed at the joints where the curved segments meet at obtuse angles may provide enhanced stiffness.

With reference now to all the FIGURES, the operation of the extendable trailer 20 will now be described. The extendable frame 30 may extend and retract to change a dimension of the trailer 20. The extendable frame 30 may extend and retract the trailer 20 along the length or longitudinal axis of the trailer 20, or along the width or transverse axis of the trailer 20, or along both axes. By changing a dimension of the trailer, the trailer 20 may receive and support different sized loads. According to one embodiment, a dimension of the extendable frame 30 is changed by unlocking the locking mechanism 88, extending or retracting the frame 30, and then locking the frame 30 in the new position. According to another embodiment, a dimension of the extendable frame 30 is changed by extending or retracting an adjustment mechanism 34, which extends or retracts the frame 30.

Numerous embodiments have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

Having thus described the invention, it is now claimed:

1. An extendable trailer frame comprising:
at least one ground engaging wheel for supporting the extendable trailer frame;
a connection device for operatively connecting the extendable trailer frame to an associated tractor;
a first support assembly;
a second support assembly; and
a tubular beam assembly operatively connecting the first and second support assemblies, the tubular beam assembly having first and second telescopically joined members, wherein the length of the tubular beam assembly changes as the first and second telescopically joined members move in relation to each other, and wherein one of the first and second telescopically joined members have a cross-section comprising a plurality of curvilinear portions joined together at obtuse angles.

2. The extendable trailer frame of claim 1 further comprising:
a locking mechanism having a locked condition and an unlocked condition, wherein the locked condition maintains the length of the tubular beam assembly, and wherein the unlocked condition allows the length of the tubular beam assembly to adjust.

3. The extendable trailer frame of claim 1 further comprising:
an adjustment mechanism for changing the length of the tubular beam assembly.

4. The extendable trailer frame of claim 3 wherein the adjustment mechanism is a hydraulic cylinder.

5. The extendable trailer frame of claim 1 further comprising:
a second tubular beam assembly operatively connecting the first and second support assemblies, the second tubular beam assembly having first and second telescopically joined members, wherein the length of the tubular beam assembly changes as the first and second telescopically joined members move in relation to each other, and wherein a cross-section of the telescopically joined members has a plurality of curvilinear portions joined together at obtuse angles.

6. The extendable trailer frame of claim 1 wherein the cross-section of the telescopically joined members includes three curvilinear portions joined together at obtuse angles.

7. The extendable trailer frame of claim 1 wherein the cross-section of the telescopically joined members further comprises a substantially linear portion positioned between two curvilinear portions, wherein the substantially linear portion and the two curvilinear portions are joined together at obtuse angles.

8. The extendable trailer frame of claim 1 wherein changing the length of the tubular beam assembly changes the length of the extendable trailer frame.

9. The extendable trailer frame of claim 1 wherein changing the length of the tubular beam assembly changes the width of the extendable trailer frame.

10. The extendable trailer frame of claim 1 wherein both the first and second telescopically joined members have cross-sections comprising a plurality of curvilinear portions joined together at obtuse angles.

11. An extendable trailer comprising:
at least one ground engaging wheel operatively connected to the extendable trailer for supporting the extendable trailer;
a connection device operatively connected to the extendable trailer for connecting the extendable trailer to an associated tractor;
a load receiving surface;
an extendable trailer frame comprising:
a front support assembly;
a rear support assembly; and
a tubular beam assembly operatively connecting the front and rear support assemblies, the tubular beam assembly having first and second telescopically joined members, wherein the length of the extendable trailer frame changes as the first and second telescopically joined members move in relation to each other, and wherein a cross-section of the telescoping joined members includes a plurality of outwardly curved portions joined together at obtuse angles.

12. The extendable trailer of claim 11 further comprising:
a locking mechanism having a locked condition and an unlocked condition, wherein the locked condition maintains the length of the extendable trailer frame, and wherein the unlocked condition allows the length of the extendable trailer frame to adjust.

13. The extendable trailer frame of claim 11 further comprising:
an adjustment mechanism for changing the length of the extendable trailer frame.

14. The extendable trailer frame of claim 13 wherein the adjustment mechanism is a hydraulic cylinder.

15. The extendable trailer frame of claim 11 further comprising:
a second tubular beam assembly operatively connecting the front and rear support assemblies, the second tubular beam assembly having first and second telescopically joined members, wherein the length of the extendable trailer frame changes as the first and second telescopically joined members move in relation to each other, and wherein a cross-section of the telescoping joined members includes a plurality of outwardly curved portions joined together at obtuse angles.

16. The extendable trailer frame of claim 11 wherein the cross-section of the telescopically joined members includes three outwardly curved portions joined together at obtuse angles.

17. The extendable trailer frame of claim 11 wherein the cross-section of the telescopically joined members further comprises a substantially linear portion positioned between two outwardly curved portions, wherein the substantially linear portion and the two outwardly curved portions are joined together at obtuse angles.

18. An extendable trailer comprising:
at least one ground engaging wheel operatively connected to the extendable trailer for supporting the extendable trailer;
a connection device operatively connected to the extendable trailer for connecting the extendable trailer to an associated tractor;
a load receiving surface; and
an extendable trailer frame comprising:
a front support assembly;
a rear support assembly; and
a tubular beam assembly operatively connecting the front and rear support assemblies, the tubular beam assembly having first and second telescopically joined members, wherein the length of the extendable trailer frame changes as the first and second telescopically joined members move in relation to each other, wherein a cross-section of the telescoping joined members includes an upper profile and a lower profile, wherein the upper profile includes a plurality of outwardly curved portions and a plurality of substantially linear portions.

19. The extendable trailer frame of claim 18 wherein the upper profile of the cross-section comprises three circular arc portions and two substantially linear portions positioned between the three circular arc portions, and wherein the circular arc portions and the substantially linear portions are joined together at straight angles.

20. The extendable trailer frame of claim 18 wherein the upper profile of the cross-section comprises three circular arc portions and two substantially linear portions positioned between the three circular arc portions, and wherein the circular arc portions and the substantially linear portions are joined together at obtuse angles.
